(19) United States
(12) Patent Application Publication
(10) Pub. No.: US 2026/0008350 A1
(43) Pub. Date: Jan. 8, 2026

(54) Apparatus and Method for Controlling Vehicle Regenerative Torque of Variable Maximum Allowable Regenerative Torque Limit

(71) Applicants: HYUNDAI MOTOR COMPANY, Seoul (KR); KIA CORPORATION, Seoul (KR)

(72) Inventors: Jin Yong Kim, Hwaseong-si (KR); Chang Eun Na, Hwaseong-si (KR)

(73) Assignees: HYUNDAI MOTOR COMPANY, Seoul (KR); KIA CORPORATION, Seoul (KR)

(21) Appl. No.: 18/927,368

(22) Filed: Oct. 25, 2024

(30) Foreign Application Priority Data
Jul. 3, 2024 (KR) 10-2024-0087543

(51) Int. Cl. B60L 7/18

(52) U.S. Cl. CPC B60L 7/18; B60L 2240/12; B60L 2240/26; B60L 2240/465; B60L 2240/667; B60L 2250/24

(57) ABSTRACT

An apparatus for controlling vehicle regenerative torque includes an information acquisition portion configured to obtain vehicle state information including a speed and a weight of a vehicle, and navigation information including weather condition information; a basic mode controller configured to enter a basic mode while the vehicle travels, to receive a variable maximum torque map determined based on information obtained by the information acquisition portion and to perform a basic mode control logic; and a safe mode controller configured to enter a safe mode when safe mode entry conditions are satisfied, and to receive a limited maximum allowable torque value determined based on information obtained by the information acquisition portion.

### CROSS-REFERENCE TO RELATED APPLICATION(S)

This application claims benefit of priority to Korean Patent Application No. 10-2024-0087543 filed on Jul. 3, 2024, in the Korean Intellectual Property Office, the disclosure of which is incorporated herein by reference in its entirety.

### TECHNICAL FIELD

The present disclosure relates to an apparatus and method for controlling vehicle regenerative torque which may be applied to a vehicle such as a commercial vehicle and may vary a limit of maximum allowable regenerative torque depending on driving conditions of the vehicle in operation.

### BACKGROUND

Generally, in a vehicle such as a commercial vehicle, regenerative braking (or regenerative brake) may be a general term for an electric braking method for converting kinetic energy into electrical energy using inertial force of a torque-driven motor (electric motor) in a closed circuit state to operate the motor as a generator by turning a rotor attached to a wheel, and thereby exerting braking force.

Since regenerative braking is usually applied only to rear-engine and rear-wheel drive (RR) vehicle, wheel slippage of a RR vehicle may occur when high regenerative torque is used in a regenerative braking control of a commercial vehicle, and accordingly, a feeling of pushing or vehicle yaw may occur.

Also, when the maximum control torque of regenerative braking is relatively large in a state in which road friction is low due to rain or snow, wheel slippage of an RR vehicle may occur, such that vehicle stability may be reduced due to a feeling of being pushed.

Considering the above-mentioned disadvantages, in a general vehicle such as a commercial vehicle, maximum torque may be used in a limited manner to prevent wheel slippage during regenerative braking control.

However, in a general vehicle such as a commercial vehicle, when there is no wheel slippage during regenerative braking control, the speed is low, the weight is relatively high, and no rain or snow falls, such that road friction is not low, and even in circumstances where the motor regenerative torque may be used more, the maximum torque may be overly limited.

### SUMMARY

An aspect of the present disclosure is to provide an apparatus and a method for controlling vehicle regenerative torque of a variable maximum allowable regenerative torque limit which may vary the limit of maximum allowable regenerative torque according to driving conditions such as weather, vehicle weight and speed of a vehicle such as a commercial vehicle when controlling regenerative braking.

The purpose of the present disclosure is not limited thereto, and a person having ordinary skill in the art will understand that other technical issues not mentioned herein could be derived from the configurations used in the specification and drawings.

According to an embodiment of the present disclosure, an apparatus for controlling vehicle regenerative torque includes an information acquisition portion configured to obtain vehicle state information including a speed and a weight of a vehicle, and navigation information including weather condition information, a basic mode controller configured to enter a basic mode while the vehicle travels, to receive a variable maximum torque map determined based on information obtained by the information acquisition portion and to perform a basic mode control logic, and a safe mode controller configured to enter a safe mode when safe mode entry conditions are satisfied, and to receive a limited maximum allowable torque value determined based on information obtained by the information acquisition portion.

The information acquisition portion may be configured to obtain surrounding object sensing information including speed information of a front vehicle, vehicle input information and wheel slippage information.

The basic mode controller may be configured to perform unit deceleration control when deceleration conditions are satisfied based on a maximum allowable torque value of the received variable maximum torque map, and to perform low-friction control when wheel slippage occurs.

The safe mode controller may be configured to determine safe mode entry conditions based on the number of times low-friction control is performed, to perform deceleration control when the deceleration condition is satisfied based on the received limited maximum allowable torque value after entering the safe mode, and to perform low-friction control when wheel slippage occurs.

The information acquisition portion may include a first information acquisition portion configured to obtain a speed and a weight of a vehicle corresponding to vehicle state information using at least one of acceleration information, yaw information, accelerator position information, motor torque information, vehicle speed information, wheel speed information and wheel slippage information. The information acquisition portion may include a second information acquisition portion configured to obtain speed camera position information and weather condition information included in the navigation information. The information acquisition portion may include a third information acquisition portion configured to obtain the surrounding object sensing information including speed and relative distance information of a front vehicle included in the surrounding object sensing information, and relative speed information. The information acquisition portion may include a fourth information acquisition portion configured to obtain vehicle input information including a regenerative braking automatic mode operation signal and a paddle shift operation signal.

The basic mode controller may include a first information input portion configured to receive vehicle state information including a vehicle speed and a vehicle weight obtained by the information acquisition portion and weather condition information including rain information or snow information. The basic mode controller may include a first maximum allowable torque determination portion configured to determine a first variable maximum torque map when no snow and rain falls, to determine a second variable maximum torque map when rain falls, and to determine a third variable maximum torque map when rain falls based on the vehicle state information and weather condition information. The basic mode controller may include a first torque controller configured to enter a basic mode when regenerative braking automatic mode is selected, to receive a variable maximum torque map determined based on current weather conditions, to operate a deceleration control logic portion within a maximum allowable torque value range of the received variable maximum torque map, and to operate a low-friction control logic portion when wheel slippage occurs.

The first maximum allowable torque determination portion may be configured to determine the first variable maximum torque map using a reference maximum allowable torque value having an increased maximum allowable torque value according to a speed and a weight of the vehicle based on the vehicle state information and weather condition information when no rain or snow falls, the first maximum allowable torque determination portion may be configured to determine a second variable maximum torque map having a maximum allowable torque value lower than the first variable maximum torque map based on the vehicle state information and weather condition information when rain falls, and the first maximum allowable torque determination portion may be configured to determine a third variable maximum torque map having a maximum allowable torque value lower than the second variable maximum torque map based on the vehicle state information and weather condition information during snowfall.

The first variable maximum torque map may include a maximum allowable torque value increasing as a vehicle weight included in the vehicle state information increases using the reference maximum allowable torque value, and may include a maximum allowable torque value increasing as a vehicle speed included in the vehicle state information decreases.

The second variable maximum torque map may include a maximum allowable torque value obtained by reducing a maximum allowable torque value of the first variable maximum torque map by a first ratio based on the weather condition information when rain falls, and the third variable maximum torque map may include a maximum allowable torque value obtained by reducing a maximum allowable torque value of the first variable maximum torque map by a second ratio during snowfall, and the second ratio is smaller than the first ratio.

The safe mode controller may include a safe mode entry determination portion configured to determine whether a safe mode entry condition is satisfied based on the number of times low-friction control is performed. The safe mode controller may include a second information input portion configured to enter a safe mode when the safe mode entry condition is satisfied by the safe mode entry determination portion, and to receive weather condition information including rain information or snow information obtained by the information acquisition portion. The safe mode controller may include a second maximum allowable torque determination portion configured to determine a first limited maximum allowable torque value when snow and rain do not fall, to determine a second limited maximum allowable torque value when rain falls, and to determine a third limited maximum allowable torque value when rain falls based on the weather condition information. The safe mode controller may include a second torque controller configured to enter a safe mode when a regenerative braking automatic mode is selected, to receive a limited maximum allowable torque value determined under current weather condition, to operate a deceleration control logic portion under a deceleration condition, and to perform a low-friction control logic portion when wheel slippage occurs within a range of the received limited maximum allowable torque value.

The second maximum allowable torque determination portion may be configured to determine a first limited maximum allowable torque value using a reference maximum allowable torque value based on the vehicle state information and weather condition information when no rain or snow falls, the second maximum allowable torque determination portion may be configured to determine a second limited maximum allowable torque value obtained by reducing the first limited maximum allowable torque value by a first ratio based on the vehicle state information and weather condition information when rain falls, and the second maximum allowable torque determination portion may be configured to determine a third limited maximum allowable torque value obtained by reducing the first limited maximum allowable torque value by a second ratio based on the vehicle state information and weather condition information during snowfall, and the second ratio is smaller than the first ratio.

The deceleration control logic portion may include a deceleration condition determination portion configured to determine whether a road on which the vehicle currently travels satisfies a deceleration condition based on information obtained by the information acquisition portion in the regenerative braking automatic mode, and a deceleration torque controller configured to control deceleration torque corresponding to the deceleration condition within a range of a maximum allowable torque value during the deceleration condition by performing a deceleration control logic when one of deceleration conditions is satisfied in the deceleration condition determination portion.

The low-friction control logic portion may include a low-friction condition determination portion configured to determine whether a on which the vehicle currently travels satisfies a low-friction condition based on the wheel slippage information in the regenerative braking automatic mode, and a low-friction torque controller configured to, when the low-friction condition is satisfied, feedback-control a low-friction torque such that a current wheel slippage value becomes a wheel slippage target value or lower during the corresponding low-friction condition by performing a low-friction control logic.

According to an embodiment of the present disclosure, a method of controlling vehicle regenerative torque includes an information obtaining operation of obtaining navigation information including vehicle state information including a speed and a weight of a vehicle and weather condition information by an information acquisition portion, a basic mode performing operation of entering a basic mode while a vehicle travels, receiving a variable maximum torque map determined based on the obtained information, and performing a basic mode control logic by a basic mode controller, and a safe mode performing operation of entering a safe mode when a safe mode entry condition is satisfied and performing a safe mode control logic by receiving a limited maximum allowable torque value determined based on information obtained by the information acquisition portion.

The information obtaining operation may further include obtaining surrounding object sensing information including speed information of a front vehicle, vehicle input information and wheel slippage information.

The basic mode performing operation may include performing deceleration control when the deceleration condition is satisfied based on a maximum allowable torque value of the received variable maximum torque map, and performing low-friction control when wheel slippage occurs.

The safe mode performing operation may include determining a safe mode entry condition based on the number of times low-friction control is performed, and after entering a safe mode, performing deceleration control when the deceleration condition is satisfied based on the received limited maximum allowable torque value, and performing low-friction control when wheel slippage occurs.

The basic mode performing operation may include a first information inputting operation of receiving vehicle state information including the obtained vehicle speed and vehicle weight and weather condition information including rain information or snow information, a first maximum allowable torque determining operation of determining a first variable maximum torque map when no snow or rain falls, determining a second variable maximum torque map when rain falls, and determining a third variable maximum torque map when rain falls based on the vehicle state information and weather condition information,; and a basic mode controlling operation of entering a basic mode when a regenerative braking automatic mode is selected, receiving a variable maximum torque map determined according to a current weather condition, performing a deceleration control logic when a deceleration condition occurs and performing a low-friction control logic when wheel slippage occurs within a range of a maximum allowable torque value of the variable maximum torque map.

The safe mode performing operation may include a safe mode entry determining operation of determining whether a safe mode entry condition is satisfied based on the number of times low-friction control is performed. The safe mode performing operation may include a second information inputting operation of entering a safe mode and receiving weather condition information including the obtained rain information or snow information when the safe mode entry condition is satisfied. The safe mode performing operation may include a second maximum allowable torque determining operation of determining a first limited maximum allowable torque value when no snow and rain falls, determining a second limited maximum allowable torque value when rain falls, and determining a third limited maximum allowable torque value when rain falls. The safe mode performing operation may include a safe mode control operation of entering a safe mode when a regenerative braking automatic mode is selected, receiving a limited maximum allowable torque value determined according to a current weather condition, performing a deceleration control logic when a deceleration condition occurs and performing a low-friction control logic when wheel slippage occurs within a range of the limited maximum allowable torque value.

The first maximum allowable torque determining operation may include determining the first variable maximum torque map having an increased maximum allowable torque value according to a speed and a weight of the vehicle using a reference maximum allowable torque value based on the vehicle state information and weather condition information when no rain or snow falls, determining the second variable maximum torque map having a maximum allowable torque value lower than a maximum allowable torque value of the first variable maximum torque map based on the vehicle state information and weather condition information when rain falls, determining a third variable maximum torque map having a maximum allowable torque value lower than a maximum allowable torque value of the second variable maximum torque map based on the vehicle state information and weather condition information during snowfall.

The first variable maximum torque map may include a maximum allowable torque value increasing as a vehicle weight included in the vehicle state information increases using the reference maximum allowable torque value, and a maximum allowable torque value increasing as a vehicle speed included in the vehicle state information decreases.

The second variable maximum torque map may include a maximum allowable torque value obtained by reducing a maximum allowable torque value of the first variable maximum torque map by a first ratio based on the weather condition information when rain falls, and the third variable maximum torque map includes a maximum allowable torque value obtained by reducing a second ratio of a maximum allowable torque value of the first variable maximum torque map based on the weather condition information during snowfall, and the second ratio is smaller than the first ratio.

The second maximum allowable torque determining operation may include determining a first limited maximum allowable torque value using a reference maximum allowable torque value based on the vehicle state information and weather condition information when no rain or snow falls, determining a second limited maximum allowable torque value obtained by reducing the first limited maximum allowable torque value by a first ratio based on the vehicle state information and weather condition information when rain falls, and determining a third limited maximum allowable torque value obtained by reducing the first limited maximum allowable torque value by a second ratio based on the vehicle state information and weather condition information during snowfall, wherein the second ratio is smaller than the first ratio.

The deceleration control logic performing operation may include a deceleration condition determining operation of determining whether a road on which the vehicle currently travels satisfies a deceleration condition based on the obtained information in the regenerative braking automatic mode, and a deceleration torque control operation of controlling deceleration torque corresponding to a deceleration condition within a range of a maximum allowable torque value during the deceleration condition by performing deceleration control logic when one of deceleration conditions is satisfied.

The low-friction control logic performing operation may include a low-friction condition determine operation of determining whether a road on which the vehicle currently travels satisfies a low-friction condition based on the wheel slippage information in the regenerative braking automatic mode, and a low-friction torque control operation of feedback-controlling low-friction torque such that a current wheel slippage value becomes a wheel slippage target value or lower during a corresponding low-friction condition by performing a low-friction control logic when the low-friction condition is satisfied.

### BRIEF DESCRIPTION OF DRAWINGS

The above and other aspects, features, and advantages of the present disclosure will be more clearly understood from the following detailed description, taken in conjunction with the accompanying drawings.

FIG. 1 is a diagram illustrating an apparatus for controlling vehicle regenerative torque according to an embodiment of the present disclosure.

FIG. 2 is a diagram illustrating an information acquisition portion according to an embodiment of the present disclosure.

FIG. 3 is a diagram illustrating a basic mode controller according to an embodiment of the present disclosure.

FIG. 4 is a graph of an example of torque of an electric motor.

FIGS. 5A, 5B, and 5C are diagrams illustrating first, second and third variable maximum torque maps according to an embodiment of the present disclosure.

FIG. 6 is a diagram illustrating a safe mode controller according to an embodiment of the present disclosure.

FIG. 7 is a diagram illustrating first, second, and third limited maximum allowable torque values according to an embodiment of the present disclosure.

FIG. 8 is a diagram illustrating a torque control operation according to a variable maximum torque map in a regenerative braking automatic mode according to an embodiment of the present disclosure.

FIG. 9 is a diagram illustrating a deceleration control logic portion according to an embodiment of the present disclosure.

FIGS. 10A, 10B, and 10C are diagrams illustrating deceleration conditions according to an embodiment of the present disclosure.

FIG. 11 is a diagram illustrating a low-friction control logic portion according to an embodiment of the present disclosure.

FIG. 12 is a flowchart illustrating a method of controlling vehicle regenerative torque according to an embodiment of the present disclosure.

FIG. 13 is a diagram illustrating an operation of determining first maximum allowable torque according to an embodiment of the present disclosure.

FIG. 14 is a diagram illustrating a second maximum allowable torque determining operation according to an embodiment of the present disclosure.

FIG. 15 is a diagram illustrating an operation of executing a deceleration control logic according to an embodiment of the present disclosure.

FIG. 16 is a diagram illustrating an operation of executing a low-friction control logic according to an embodiment of the present disclosure.

FIG. 17 is a block diagram illustrating a computing device 1000 which may fully or partially implement an apparatus and a method for controlling vehicle regenerative torque of a variable maximum allowable regenerative torque limit.

### DETAILED DESCRIPTION

Hereinafter, embodiments of the present disclosure will be described with reference to the attached drawings.

The redundant descriptions and detailed descriptions of known functions and elements which may unnecessarily make the gist of the present disclosure obscure will not be provided. In the accompanying drawings, some elements may be exaggerated, omitted or briefly illustrated, and the sizes of the elements do not necessarily reflect the actual sizes of these elements. The terms, “include,” “comprise,” “is configured to,” or the like of the description are used to indicate the presence of features, numbers, steps, operations, elements, portions or combination thereof, and do not exclude the possibilities of combination or addition of one or more features, numbers, steps, operations, elements, portions or combination thereof.

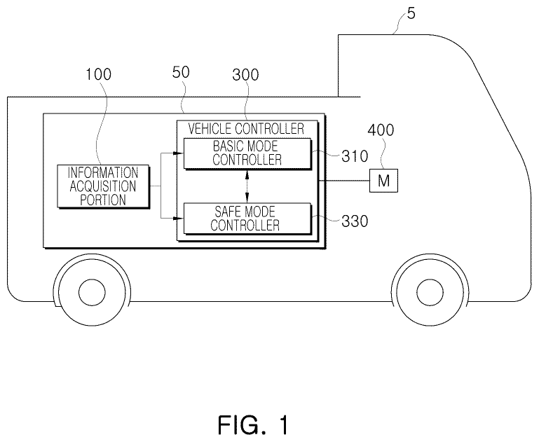

FIG. 1 is a diagram illustrating an apparatus for controlling vehicle regenerative torque according to an embodiment.

Referring to FIG. 1, an apparatus for controlling vehicle regenerative torque 50 according to an embodiment may be mounted on a vehicle 5, such as a commercial vehicle, and may include an information acquisition portion 100, a basic mode controller 310, and a safe mode controller 330. For example, the basic mode controller 310 and the safe mode controller 330 may be included in the vehicle controller 300.

The information acquisition portion 100 may obtain vehicle state information including a speed and a weight of the vehicle, and navigation information including weather condition information.

The basic mode controller 310 may enter a basic mode while the vehicle travels, may receive variable maximum torque maps MAP1, MAP2, and MAP3 determined based on the information obtained by the information acquisition portion 100, and may perform basic mode control logic.

The safe mode controller 330 may enter a safe mode when a safe mode entry condition is satisfied based on the number of times low-friction control is performed, may receive the limited maximum allowable torque values MT1, MT2, and MT3 determined based on the information obtained by the information acquisition portion 100, and may perform the safe mode control logic.

Also, the information acquisition portion 100 may further obtain surrounding object sensing information including speed information of a front vehicle, vehicle input information, and wheel slippage information.

In this case, the basic mode controller 310 may perform deceleration control when the deceleration condition is satisfied based on the maximum allowable torque value of the received variable maximum torque map and may perform low-friction control when wheel slippage occurs.

The safe mode controller 330 may determine a safe mode entry condition based on the number of times low-friction control is performed, and after entering the safe mode, the safe mode controller 330 may perform deceleration control when a deceleration condition is satisfied based on the received limited maximum allowable torque values MT1, MT2, and MT3, and may perform low-friction control when wheel slippage occurs.

The apparatus for controlling vehicle regenerative torque 50 described above may control regenerative braking torque for the motor (M) 400 of the vehicle 5.

In one embodiment, the information acquisition portion 100, the basic mode controller 310, and the safe mode controller 330 may be implemented individual processors, or may be implemented as an integrated processor, but an embodiment thereof is not limited thereto.

Also, the information acquisition portion 100, the basic mode controller 310, and the safe mode controller 330 may be implemented as hardware element(s) or software element(s) or a combination thereof in at least one integrated circuit (IC) embedded in the apparatus for controlling vehicle regenerative torque 50, but an embodiment thereof is not limited thereto.

As for each drawing of the embodiment, unnecessary redundant descriptions of components having the same symbol and the same function may not be provided, and possible differences between the drawings may be described.

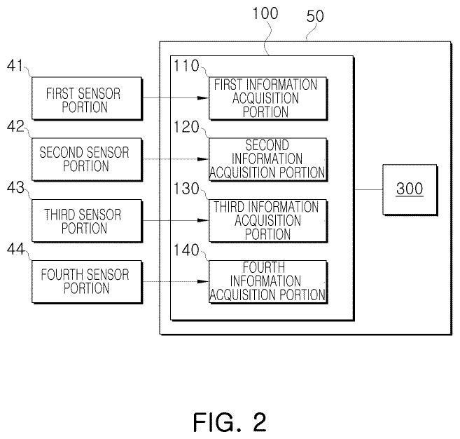

FIG. 2 is a diagram illustrating an information acquisition portion according to an embodiment.

Referring to FIG. 2, an information acquisition portion 100 may include a first information acquisition portion 110, a second information acquisition portion 120, a third information acquisition portion 130, and a fourth information acquisition portion 140.

The first information acquisition portion 110 may obtain a speed and a weight of the vehicle corresponding to the vehicle state information using at least one of acceleration information, yaw information, accelerator position information, motor torque information, vehicle speed information, wheel speed information, and wheel slippage information. For example, the first information acquisition portion 110 may obtain the information through the first sensor portion 41, and the first sensor portion 41 may include at least one of an acceleration sensor, a yaw sensor, an accelerator pedal position sensor, a motor torque sensor, a vehicle speed sensor, and a wheel speed (wheel rotation speed) sensor. For example, the first information acquisition portion 110 may estimate a vehicle speed and weight using the acceleration information or the wheel speed information, and may obtain wheel slippage information using the vehicle speed and the wheel speed.

The second information acquisition portion 120 may obtain speed camera position information and weather condition information included in the navigation information. For example, the second information acquisition portion 120 may obtain the information through the second sensor portion 42, and the second sensor portion 42 may be implemented as a navigation device which may provide speed camera position information and weather condition information. For example, the second information acquisition portion 120 may obtain road slope information when the navigation information of the navigation device includes road slope information.

The third information acquisition portion 130 may obtain the surrounding object sensing information including speed and relative distance information of the front vehicle included in the surrounding object sensing information, and the surrounding object sensing information including the relative speed information. For example, the third information acquisition portion 130 may obtain the information through the third sensor portion 43, and the third sensor portion 43 may include at least one of the front vehicle, a radar device, and a lidar device for detecting the forward-looking camera and measuring a speed and distance of the front vehicle.

The fourth information acquisition portion 140 may obtain vehicle input information related to the operation or manipulation of an internal device of the vehicle, such as a regenerative braking automatic mode operation signal and a paddle shift operation signal. For example, the fourth information acquisition portion 140 may obtain the information through the fourth sensor portion 44, and the fourth sensor portion 44 may include at least one of an SRS (Smart Regenerative braking System) device providing an SRS operation signal and a paddle shift sensor providing a paddle shift operation signal.

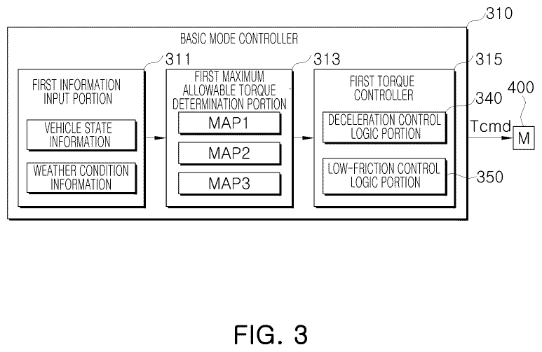

FIG. 3 is a diagram illustrating a basic mode controller according to an embodiment.

Referring to FIG. 3, a basic mode controller 310 may include a first information input portion 311, a first maximum allowable torque determination portion 313, and a first torque controller 315.

The first information input portion 311 may receive vehicle state information including vehicle speed and vehicle weight obtained by the information acquisition portion 100 and weather condition information including rain information or snow information.

The first maximum allowable torque determination portion 313 may determine a first variable maximum torque map MAP1 when no snow and rain falls, may determine a second variable maximum torque map MAP2 when rain falls, and may determine a third variable maximum torque map MAP3 when rain falls, based on the vehicle state information and weather condition information.

When the regenerative braking automatic mode is selected, the first torque controller 315 may enter a basic mode, may receive a variable maximum torque map determined according to a current weather condition, and may perform deceleration control logic when a deceleration condition occurs and may perform low-friction control logic when wheel slippage occurs within a range of a maximum allowable torque value of the variable maximum torque map.

For example, the first torque controller 315 may include a deceleration control logic portion 340 performing deceleration control logic when a deceleration condition occurs and a low-friction control logic portion 350 performing low-friction control logic.

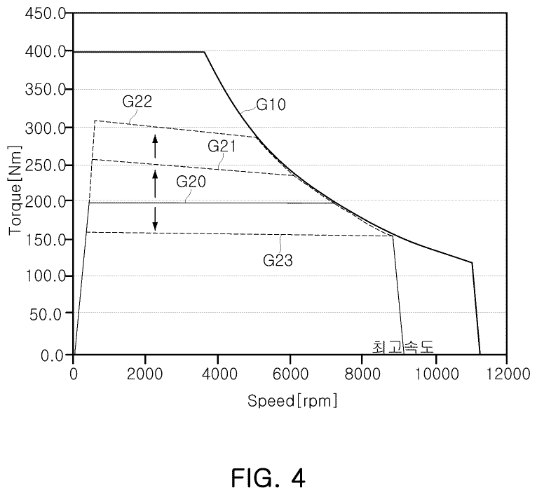

FIG. 4 is a graph of an example of torque of an electric motor.

In the torque diagram graph of the electric motor illustrated in FIG. 4, the vertical axis is torque [Nm] (e.g., Newton meter), the horizontal axis is speed [rpm] (e.g., rpm is revolutions per minute), G10 is a graph illustrating the torque diagram characteristics of the electric motor, G20 is a reference maximum allowable torque value (e.g., 200 Nm), G21 and G22 are graphs indicating increased maximum allowable torque values, and G23 is a graph indicating decreased maximum allowable torque values.

As illustrated in FIG. 4, the maximum allowable torque value is not fixed, and using the reference maximum allowable torque value (e.g., 200 Nm) illustrated in G20 as a basic value, and the maximum allowable torque value may increase depending on the speed and weight of the vehicle, and the maximum allowable torque value may decrease depending on the weather, such as rain or snow.

Accordingly, in the embodiment, the maximum allowable torque value may vary depending on the speed, weight, and weather of the vehicle. The figures in the graph illustrated in FIG. 4 are merely an example, and an embodiment thereof is not limited thereto.

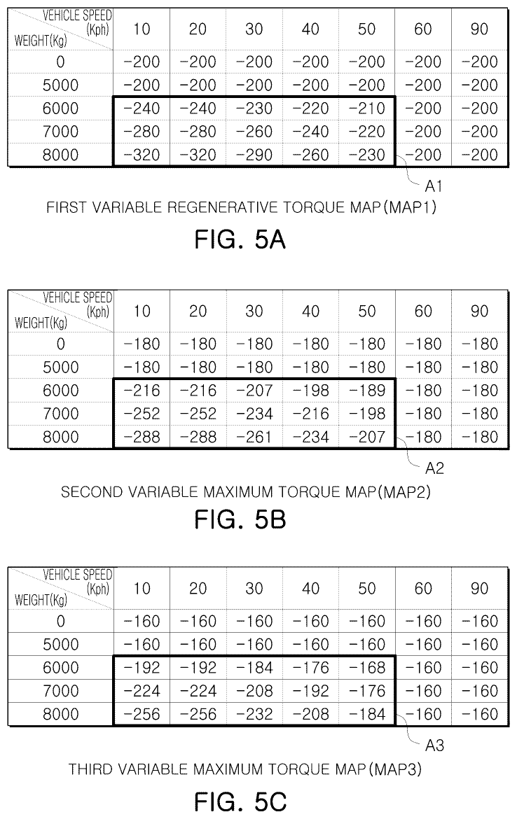

FIGS. 5A, 5B, and 5C are diagrams illustrating first, second and third variable maximum torque maps according to an embodiment.

Referring to FIG. 5A, the first maximum allowable torque determination portion 313 may determine a first variable maximum torque map MAP1 having a maximum allowable torque value increased according to a speed of the vehicle in kph (kilometers per hour) and weight of the vehicle in kg (kilograms) using the reference maximum allowable torque value when no rain or snow falls based on vehicle state information and weather condition information.

For example, the first variable maximum torque map MAP1 may include a maximum allowable torque value (refer to A1) increasing as a vehicle weight included in the vehicle state information increases, and a maximum allowable torque value (refer to A1) increasing as a vehicle speed included in the vehicle state information decreases using the reference maximum allowable torque value (e.g., −200 Nm).

Referring to FIG. 5B, the first maximum allowable torque determination portion 313 may determine a second variable maximum torque map MAP2 having a maximum allowable torque value lower than the maximum allowable torque value of the first variable maximum torque map MAP1 based on the vehicle state information and weather condition information in case of rain.

For example, the second variable maximum torque map MAP2 may include a maximum allowable torque value obtained by reducing the maximum allowable torque value of the first variable maximum torque map MAP1 by a first ratio based on the weather condition information in case of rain.

For example, the first variable maximum torque map MAP2 may include a maximum allowable torque value (refer to A2) increasing as a vehicle weight included in the vehicle state information increases, and a maximum allowable torque value (refer to A2) increasing as a vehicle speed included in the vehicle state information decreases using the reference maximum allowable torque value (e.g., −180 Nm).

Referring to FIG. 5C, the first maximum allowable torque determination portion 313 may determine a third variable maximum torque map MAP3 having a maximum allowable torque value lower than the maximum allowable torque value of the second variable maximum torque map MAP2 in case of snow based on the vehicle state information and weather condition information. For example, the first ratio may be 0.9, and an embodiment thereof is not limited thereto.

For example, the third variable maximum torque map MAP3 may include a maximum allowable torque value obtained by reducing the maximum allowable torque value of the first variable maximum torque map MAP1 to a second ratio based on the weather condition information in case of snow, and the second ratio may be smaller than the first ratio, and for example, the first ratio may be 0.9, the second ratio may be 0.8, and an embodiment thereof is not limited thereto.

For example, the first variable maximum torque map MAP1 may include a maximum allowable torque value (refer to A3) increasing as a vehicle weight included in the vehicle state information increases, and a maximum allowable torque value (refer to A3) increasing as a vehicle speed included in the vehicle state information decreases using the reference maximum allowable torque value (e.g., −160 Nm).

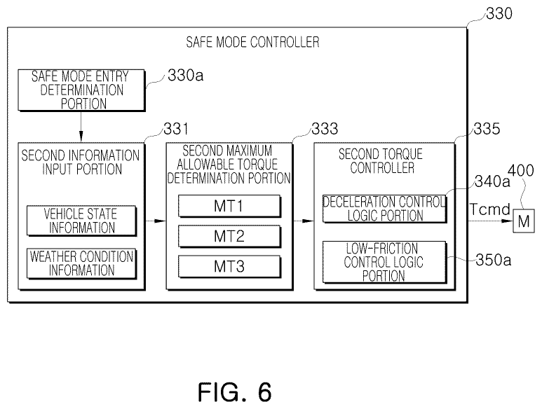

FIG. 6 is a diagram illustrating a safe mode controller according to an embodiment.

Referring to FIG. 6, the safe mode controller 330 may include a safe mode entry determination portion 330a, a second information input portion 331, a second maximum allowable torque determination portion 333, and a second torque controller 335.

The safe mode entry determination portion 330a may determine whether a safe mode entry condition is satisfied based on the number of times low-friction control is performed. For example, the safe mode entry condition may refer to the condition in which the number of repetitions of entering and releasing low-friction control is equal to or greater than a predetermined number of times, and as an example, the predetermined number of times may be 2. As an example, when the number of times of repeating entering and releasing (or exiting) low-friction control is equal to or greater than the determined number of times, the driving condition may be recognized as unfavorable and the safe mode may be entered.

The second information input portion 331 may enter the safe mode when the safe mode entry condition is satisfied by the safe mode entry determination portion 330a, and may receive weather condition information including rain information or snow information obtained by the information acquisition portion 100.

The second maximum allowable torque determination portion 333 may determine a first limited maximum allowable torque value MT1 when no snow and rain falls, may determine a second limited maximum allowable torque value MT2 when rain falls, and may determine a third limited maximum allowable torque value MT3 when rain falls, based on the weather condition information.

The second torque controller 335 may enter the safe mode when the regenerative braking automatic mode is selected, may receive a limited maximum allowable torque value determined according to the current weather condition, may perform deceleration control logic in the case of a deceleration condition and may perform low-friction control logic in the case of wheel slippage within the range of the limited maximum allowable torque value.

For example, the second torque controller 335 may include a deceleration control logic portion 340a performing deceleration control logic in the case of a deceleration condition and a low-friction control logic portion 350a performing low-friction control logic.

In the embodiment, in the safe control mode, the first limited maximum allowable torque value MT1 may be determined as the reference maximum allowable torque value (e.g., −200 Nm), the second limited maximum allowable torque value MT2 may be determined by reducing the first limited maximum allowable torque value MT1 by the first ratio, and the third limited maximum allowable torque value MT3 may be determined by reducing the first limited maximum allowable torque value MT1 by the first ratio. The second ratio may be smaller than the first ratio, for example, the first ratio may be 0.9, the second ratio may be 0.8, and an embodiment thereof is not limited thereto.

The maximum allowable torque value of regenerative braking to a torque lower than the reference maximum allowable torque value (e.g., −200 Nm) without increasing may be limited by considering conditions of road where wheel slippage frequently occurs, and may be to reduce heterogeneity and to assure maximum stability.

In the regenerative braking automatic mode, when wheel slippage occurs due to reduced road friction while performing the basic control mode, the apparatus for controlling vehicle regenerative torque 50 may transfer control from the basic mode controller 310 to the safe mode controller 330. In this case, the motor may no longer estimate the torque command of the basic mode controller 310, and may estimate the torque command of the safe mode controller 330.

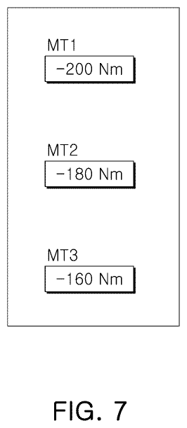

FIG. 7 is a diagram illustrating first, second, and third limited maximum allowable torque values according to an embodiment.

Referring to FIG. 7, the second maximum allowable torque determination portion 333 may determine a first limited maximum allowable torque value MT1 using a reference maximum allowable torque value based on vehicle state information and weather condition information, when rain or snow do not fall.

The second maximum allowable torque determination portion 333 may determine a second limited maximum allowable torque value MT2 obtained by reducing the first limited maximum allowable torque value MT1 by a first ratio when rain falls based on the vehicle state information and weather condition information. For example, the first ratio may be 0.9, and an embodiment thereof is not limited thereto.

The second maximum allowable torque determination portion 333 may determine a third limited maximum allowable torque value MT3 obtained by reducing the first limited maximum allowable torque value MT1 by a second ratio based on the vehicle state information and weather condition information, during snowfall. The second ratio may be smaller than the first ratio. For example, the first ratio may be 0.9, the second ratio may be 0.8, and an embodiment thereof is not limited thereto.

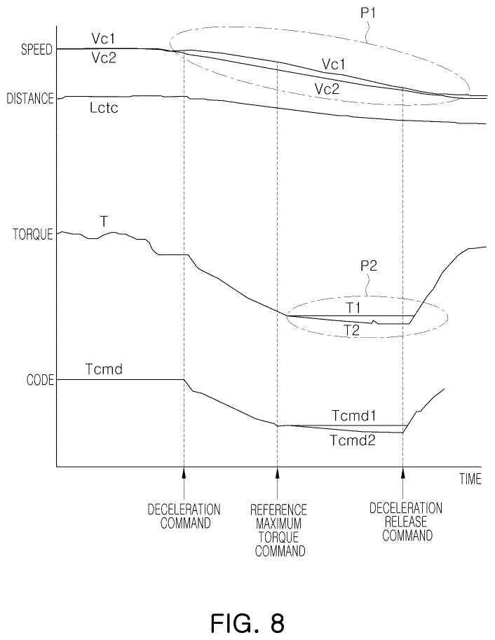

FIG. 8 is a diagram illustrating a torque control operation according to a variable maximum torque map in a regenerative braking automatic mode according to an embodiment.

Referring to FIG. 8, Tcmd is a code value corresponding to the torque control command (torque control command value), T is the motor torque, Lctc is the distance between the vehicle including the apparatus for controlling vehicle regenerative torque 50 in FIG. 1 and another vehicle traveling around the vehicle, Vc1 is the vehicle speed, and Vc2 is the speed of the vehicle (e.g., front vehicle) in front of the vehicle.

For example, according to the distance between the vehicles (Lctc), in a circumstance in which the front vehicle is gradually approaching, when regenerative braking is automatically controlled by the front vehicle braking, the code value corresponding to the torque control command may gradually decrease to the reference maximum allowable torque value, and may be maintained as the reference maximum allowable torque command value Tcmd1 previously, but in the embodiment, the maximum allowable torque command value Tcmd2 may gradually increase (the downward direction in the graph of FIG. 7 is the increasing direction).

Accordingly, in the motor torque T, the previous motor torque T1 may be maintained constant (e.g., −180 Nm) with reference to the second display region P2, but in the embodiment, since the variable maximum torque map is used, the motor torque T2 may increase the regenerative torque from “−180 Nm” to “−220 Nm” depending on the speed. In other words, among the example values, as for −180 Nm and −220 Nm, other than “-” indicating the direction, the pure torque value may increase from 180 Nm to 220 Nm.

Ultimately, torque control may be performed such that the vehicle speed Vc1 may become the same as the front vehicle speed with reference to the first display region P1.

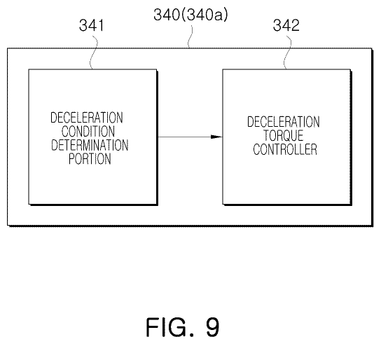

FIG. 9 is a diagram illustrating a deceleration control logic portion according to an embodiment. Referring to FIG. 9, the deceleration control logic portion 340 may include a deceleration condition determination portion 341, and a deceleration torque controller 342.

In the regenerative braking automatic mode, the deceleration condition determination portion 341 may determine whether a road on which a vehicle travels corresponds to a deceleration condition based on information obtained by the information acquisition portion. For example, the deceleration condition may be a downhill road, a speed limitation road, a road on which a front vehicle is present, and an embodiment thereof is not limited thereto.

When one of the deceleration conditions is satisfied in the deceleration condition determination portion 341, the deceleration torque controller 342 may control the deceleration torque corresponding to the deceleration condition within the range of the maximum allowable torque value during the deceleration condition by performing deceleration control logic. Here, the deceleration torque controller 342 may enter deceleration control when the deceleration condition is satisfied and may perform deceleration control, and may release the deceleration control when released.

For example, the deceleration torque controller 342 may obtain a deceleration value for each deceleration condition based on the basic deceleration value for deceleration control, and may control the torque of the motor by obtaining the required torque based on the deceleration value for each deceleration condition. For example, a plurality of deceleration conditions may include the condition in which the road is downhill, the condition in which there is a speed limitation, the condition in which a front vehicle is present, and an embodiment thereof is not limited thereto.

For example, the deceleration torque controller 342 may calculate deceleration according to deceleration conditions based on a pre-determined deceleration value when traveling on a normal road, in the case of deceleration by a front vehicle, deceleration may be calculated for each deceleration condition using the front vehicle speed, vehicle speed, and distance from the front vehicle, in the case of deceleration due to speed limitation based on a speed camera, the deceleration may be calculated using the vehicle speed, speed camera limit speed, and distance to the speed camera, and when maintaining speed while traveling downhill, deceleration may be calculated based on vehicle speed and driver-set speed.

For example, when the deceleration control logic portion 342 receives a determined first variable maximum torque map MAP1, torque of the motor 400 may be controlled using a torque control command value Tcmd based on a torque value according to the deceleration condition within a range of the maximum allowable torque values corresponding to the current vehicle speed and weight among the maximum allowable torque values included in the first variable maximum torque map MAP1.

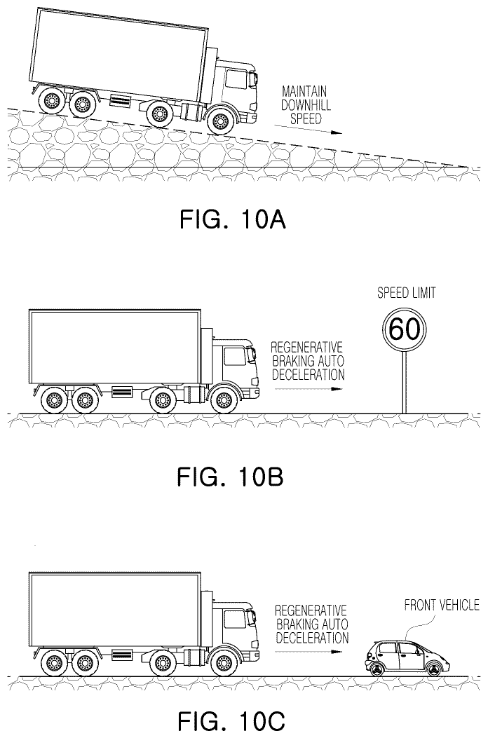

FIGS. 10A, 10B, and 10C are diagrams illustrating deceleration conditions according to an embodiment.

FIG. 10A is an example in which it may be necessary to maintain the vehicle speed to be constant under the condition in which the road is downhill among the plurality of deceleration conditions.

FIG. 10B is an example in which automatic deceleration is required under the condition in which there is a speed limitation based on a surveillance camera among the plurality of deceleration conditions.

FIG. 10C is an example in which automatic deceleration is required under the condition in which a front vehicle is present among the plurality of deceleration conditions.

As described above, the examples illustrated in FIGS. 10A, 10B, and 10C are merely examples of deceleration conditions, and an embodiment thereof is not limited thereto.

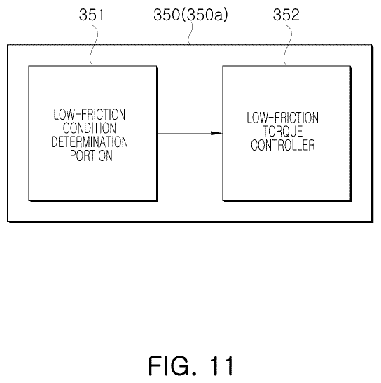

FIG. 11 is a diagram illustrating a low-friction control logic portion according to an embodiment.

Referring to FIG. 11, the low-friction control logic portion 350 and 350a may include a low-friction condition determination portion 351, and a low-friction torque controller 352.

In the regenerative braking automatic mode, the low-friction condition determination portion 351 may determine whether the road on which a vehicle currently travels is in a low-friction condition based on the wheel slippage information.

The low-friction torque controller 352 may perform low-friction control logic when the low-friction condition is satisfied, and may feedback-control the low-friction torque such that the current wheel slippage value may become a wheel slippage target value (e.g., 2%) or lower during the low-friction condition. For example, a proportional-integral-differential (PID) controller may be used for feedback control, and an embodiment thereof is not limited thereto.

For example, a low-friction condition for entering low-friction control may be determined as a wheel slippage rate of 10% or more, and a low-friction control exit may be determined as a control torque of −100 Nm, and an embodiment thereof is not limited thereto.

For example, the low-friction controller 352 may enter low-friction control when the wheel slippage rate is 10% or more during the regenerative braking automatic mode, and while performing low-friction control, the wheel slippage rate may be checked by gradually lowering the control torque from −1000 Nm to −500 Nm, to −100 Nm, and to −50 Nm until the wheel slippage rate is within the wheel slippage target value (e.g., 2%). Conversely, when the wheel slippage rate is the wheel slippage target value (e.g., 2%) or lower, the control torque may be gradually increased. For example, when the wheel slippage rate is 1% at the control torque of −50 Nm, the low-friction controller 352 may be released from the low-friction control when the wheel slippage rate is the wheel slippage target value (e.g., 2%) or lower even when the control torque is increased by −100 Nm or more.

As described above, while the safe mode is performed by the safe mode controller 330, the target wheel slippage rate may be lowered to 2% and extremely small torque control may be performed. For example, when the low-friction control is performed, when the control torque is a constant value or higher within the range satisfying the target wheel slippage rate of 2%, the low-friction control may be released and the control torque may be returned to the normal regenerative braking control.

For example, determining of wheel slippage may use an anti-lock braking system (ABS) flag signal determined to be logic portion “1” when wheel slippage occurs, and this is merely an example, and an embodiment thereof is not limited thereto.

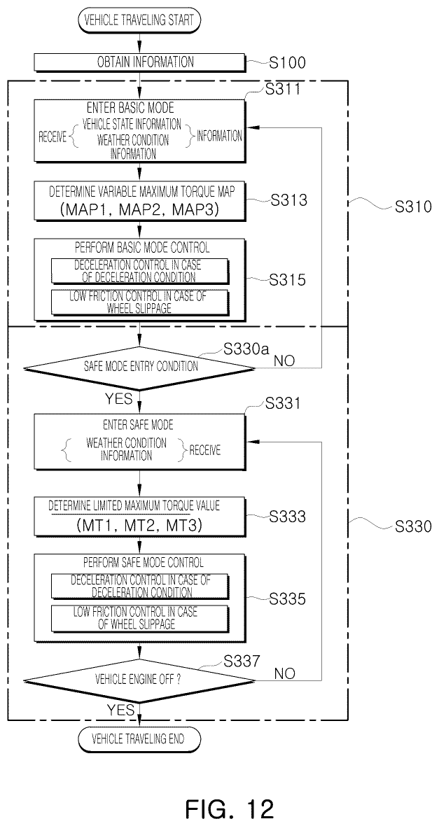

Hereinafter, with reference to FIG. 12, the method of controlling vehicle regenerative torque will be described. In the embodiment, the description of the method of controlling vehicle regenerative torque and the description of the apparatus for controlling vehicle regenerative torque may be applied complementarily or in common, unless otherwise indicated. Accordingly, overlapping descriptions will not be provided. Hereinafter, the main process of the method of controlling vehicle regenerative torque will be described.

FIG. 12 is a flowchart illustrating a method of controlling vehicle regenerative torque according to an embodiment.

Referring to FIG. 1 and FIG. 12, the method of controlling vehicle regenerative torque according to an embodiment may be performed by, for example, the apparatus for controlling vehicle regenerative torque 50 mounted on the vehicle 5 illustrated in FIG. 1.

The method of controlling vehicle regenerative torque may include an information obtaining operation (S100), a basic mode performing operation (S310), and a safe mode performing operation (S330).

In the information obtaining operation (S100), the information acquisition portion 100 of the apparatus for controlling vehicle regenerative torque 50 (see FIG. 1) may obtain vehicle state information including a speed and weight of the vehicle and navigation information including weather condition information.

In the basic mode performing operation (S310), the basic mode controller 310 of the apparatus for controlling vehicle regenerative torque 50 (see FIG. 1) may enter the basic mode when the vehicle travels, may receive variable maximum torque maps MAP1, MAP2, and MAP3 determined based on the obtained information, and may perform basic mode control logic.

In the safe mode performing operation (S330), the safe mode controller 330 of the apparatus for controlling vehicle regenerative torque 50 (see FIG. 1) may enter the safe mode when the safe mode entry condition is satisfied, may receive the limited maximum allowable torque values MT1, MT2, and MT3 determined based on the information obtained by the information acquisition portion 100 and may perform the safe mode control logic.

Also, in the information obtaining operation (S100), the information acquisition portion 100 of the apparatus for controlling vehicle regenerative torque 50 (see FIG. 1) may further obtain surrounding object sensing information including speed information of a front vehicle, vehicle input information, and wheel slippage information.

In this case, in the basic mode performing operation (S310), the basic mode controller 310 of the apparatus for controlling vehicle regenerative torque 50 (see FIG. 1) may perform deceleration control when a deceleration condition is satisfied based on the maximum allowable torque value of the received variable maximum torque map and may perform low-friction control when wheel slippage occurs.

In the safe mode performing operation (S330), the safe mode controller 330 of the apparatus for controlling vehicle regenerative torque 50 (see FIG. 1) may determine a safe mode entry condition based on the number of times low-friction control is performed, and after entering the safe mode, the apparatus may perform deceleration control when a deceleration condition is satisfied based on the received limited maximum allowable torque values MT1, MT2, and MT3, and may perform a safe mode control logic for performing low-friction control when wheel slippage occurs.

Also, referring to FIG. 12, the basic mode performing operation (S310) may include a first information inputting operation (S311), a first maximum allowable torque determining operation (S313), and a basic mode controlling operation (S315).

In the first information inputting operation (S311), the basic mode controller 310 of the apparatus for controlling vehicle regenerative torque 50 (see FIG. 1) may receive vehicle state information including the obtained vehicle speed and vehicle weight and weather condition information including rain information or snow information.

In the first maximum allowable torque determining operation (S313), the basic mode controller 310 of the apparatus for controlling vehicle regenerative torque 50 (see FIG. 1) may determine a first variable maximum torque map MAP1 when snow and rain do not fall, may determine a second variable maximum torque map MAP2 when rain falls, and may determine a third variable maximum torque map MAP3 when rain falls, based on the vehicle state information and weather condition information.

In the basic mode controlling operation (S315), the basic mode controller 310 of the apparatus for controlling vehicle regenerative torque 50 (see FIG. 1) may enter the basic mode when the regenerative braking automatic mode is selected, may receive a variable maximum torque map determined according to a current weather condition, may perform the deceleration control logic portion 340 in the case of a deceleration condition, and may perform the low-friction control logic portion 350 in the case of wheel slippage within the range of the maximum allowable torque value of the variable maximum torque map.

The safe mode performing operation (S330) may include a safe mode entry determining operation (S330a), a second information inputting operation (S331), a second maximum allowable torque determination portion (S333), and a safe mode control operation (S335).

In the safe mode entry determining operation (S330a), the safe mode controller 330 of the apparatus for controlling vehicle regenerative torque 50 (see FIG. 1) may determine whether a safe mode entry condition is satisfied based on the number of times low-friction control is performed.

In the second information inputting operation (S331), the safe mode controller 330 of the apparatus for controlling vehicle regenerative torque 50 (see FIG. 1) may enter the safe mode when the safe mode entry condition is satisfied, and may receive weather condition information including the obtained rain information or snow information. In the second maximum allowable torque determining operation (S333), the safe mode controller 330 of the apparatus for controlling vehicle regenerative torque 50 (see FIG. 1) may determine a first limited maximum allowable torque value MT1 when no snow or rain falls, may determine a second limited maximum allowable torque value MT2 when rain falls, and may determine a third limited maximum allowable torque value MT3 when rain falls, based on the weather condition information.

In safe mode control operation (S335), the safe mode controller 330 of the apparatus for controlling vehicle regenerative torque 50 (see FIG. 1) may enter the safe mode when the regenerative braking automatic mode is selected, may receive a limited maximum allowable torque value determined according to a current weather condition, may perform the deceleration control logic portion 340a in the case of a deceleration condition, and may perform the low-friction control logic portion 350a in the case of wheel slippage within the range of the limited maximum allowable torque value.

Also, during safe mode control, when the vehicle ignition is not turned off, safe mode control may be performed, and when the vehicle engine is turned off, vehicle traveling may be terminated (S337).

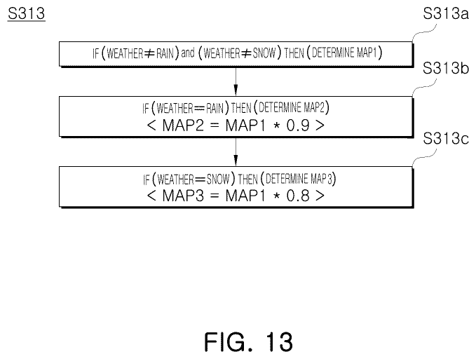

FIG. 13 is a diagram illustrating an operation of determining the first maximum allowable torque according to an embodiment.

Referring to FIG. 13, in the first maximum allowable torque determining operation (S313), the basic mode controller 310 of the apparatus for controlling vehicle regenerative torque 50 (see FIG. 1) may determine a first variable maximum torque map MAP1 having a maximum allowable torque value increased according to the speed and weight of the vehicle using the reference maximum allowable torque value based on the vehicle state information and weather condition information, when rain or snow do not fall.

In the first maximum allowable torque determining operation (S313), the basic mode controller 310 of the apparatus for controlling vehicle regenerative torque 50 (see FIG. 1) may determine a second variable maximum torque map MAP2 having a maximum allowable torque value lower than the maximum allowable torque value of the first variable maximum torque map MAP1 based on the vehicle state information and weather condition information, when rain falls.

In the first maximum allowable torque determining operation (S313), the basic mode controller 310 of the apparatus for controlling vehicle regenerative torque 50 (see FIG. 1) may determine a third variable maximum torque map MAP3 having a lower maximum allowable torque value than the maximum allowable torque value of the second variable maximum torque map MAP2 based on the vehicle state information and weather condition information during snowfall.

Also, referring to FIG. 13, the first variable maximum torque map MAP1 may include a maximum allowable torque value increasing as the vehicle weight included in the vehicle state information increases using the reference maximum allowable torque value (e.g., −200 Nm), and may include a maximum allowable torque value increasing as the vehicle speed included in the vehicle state information decreases (S313a). The second variable maximum torque map MAP2 may include a maximum allowable torque value obtained by reducing the maximum allowable torque value of the first variable maximum torque map MAPI by a first ratio based on the weather condition information in case of rain (S313b). The third variable maximum torque map MAP3 may include a maximum allowable torque value obtained by reducing the maximum allowable torque value of the first variable maximum torque map MAP1 by the second ratio based on the weather condition information in case of snow (S313c). For example, the second ratio (e.g., 0.8) may be smaller than the first ratio (e.g., 0.9).

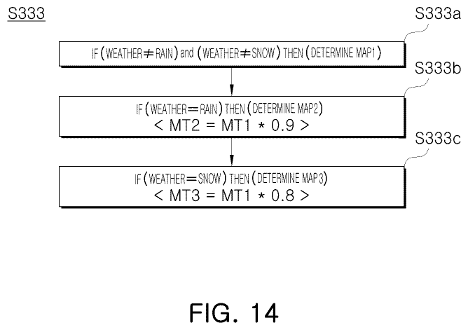

FIG. 14 is a diagram illustrating a second maximum allowable torque determining operation according to an embodiment.

Referring to FIG. 14, in the second maximum allowable torque determining operation (S333), the safe mode controller 330 of the apparatus for controlling vehicle regenerative torque 50 (see FIG. 1) may determine the first limited maximum allowable torque value MT1 using the reference maximum allowable torque value based on the vehicle state information and weather condition information when rain or snow do not fall (S333a).

In the second maximum allowable torque determining operation (S333), the safe mode controller 330 of the apparatus for controlling vehicle regenerative torque 50 (see FIG. 1) may determine the second limited maximum allowable torque value MT2 obtained by reducing the first limited maximum allowable torque value MT1 by the first ratio based on the vehicle state information and weather condition information when rain falls (S333b).

In the second maximum allowable torque determining operation (S333), the safe mode controller 330 of the apparatus for controlling vehicle regenerative torque 50 (see FIG. 1) may determine a third limited maximum allowable torque value MT3 obtained by reducing the first limited maximum allowable torque value MT1 by a second ratio based on the vehicle state information and weather condition information during snowfall. For example, the second ratio may be smaller than the first ratio (S313c).

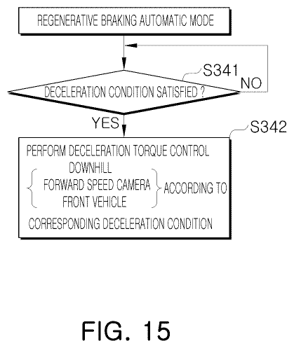

FIG. 15 is a diagram illustrating an operation of executing a deceleration control logic according to an embodiment.

Referring to FIG. 15, the deceleration control logic performing operation may include a deceleration condition determining operation (S341), and a deceleration torque control operation (S342).

In the deceleration condition determining operation (S341), the apparatus for controlling vehicle regenerative torque 50 (see FIG. 1) may determine whether the road on which the vehicle currently travels corresponds to a deceleration condition based on the obtained information in the regenerative braking automatic mode.

In the deceleration torque control operation (S342), the apparatus for controlling vehicle regenerative torque 50 (see FIG. 1) may control the deceleration torque corresponding to the deceleration condition within the range of the maximum allowable torque value during the deceleration condition when one of the deceleration conditions corresponds by performing the deceleration control logic.

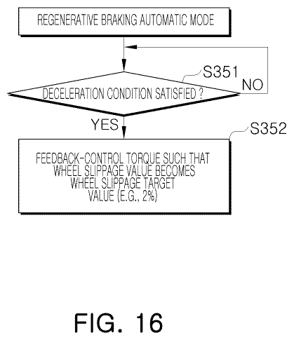

FIG. 16 is a diagram illustrating an operation of executing a low-friction control logic according to an embodiment.

Referring to FIG. 16, the low-friction control logic performing operation may include a low-friction condition determine operation (S351), and a low-friction torque control operation (S352).

In the low-friction condition determine operation (S351), the apparatus for controlling vehicle regenerative torque 50 (see FIG. 1) may determine whether the road on which the vehicle currently travels corresponds to a low-friction condition based on the wheel slippage information in the regenerative braking automatic mode.

In the low-friction torque control operation (S352), when the low-friction condition is satisfied, the apparatus for controlling vehicle regenerative torque 50 (see FIG. 1) may feedback-control the low-friction torque such that the current wheel slippage value becomes the wheel slippage target value (e.g., 2%) or lower during the corresponding low-friction condition by performing low-friction control logic.

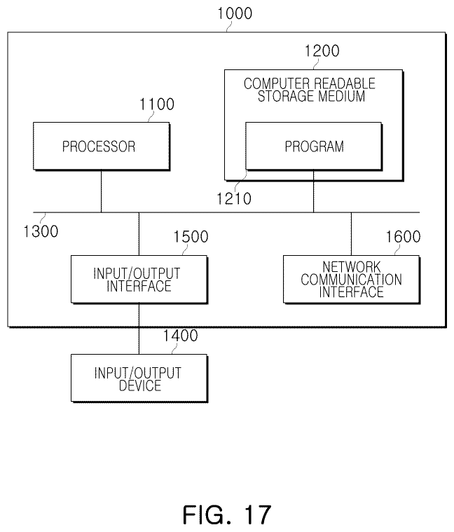

FIG. 17 is a block diagram illustrating a computing device 1000 which may fully or partially implement an apparatus and a method for controlling vehicle regenerative torque of a variable maximum allowable regenerative torque limit.

As illustrated in FIG. 17, the computing device 1000 may include at least one processor 1100, a computer readable storage medium 1200, and a communication bus 1300.

The processor 1100 may cause the computing device 1000 to operate according to the above-mentioned embodiment. For example, the processor 1100 may execute one or more programs stored in the computer readable storage medium 1200. The one or more programs may include one or more computer-executable instructions, and computer-executable instructions may be configured to allow the computing device 1000 to perform operations according to the embodiment when executed by the processor 1100.

The computer readable storage medium 1200 may be configured to store computer-executable instructions or program code, program data, and/or other suitable forms of information. A program 1210 stored in a computer readable storage medium 1200 may include a set of instructions executable by the processor 1100. In an embodiment, the computer readable storage medium 1200 may be implemented as a memory (volatile memory, such as random access memory, nonvolatile memory, or a suitable combination thereof), one or more magnetic disk storage devices, optical disk storage devices, flash memory devices, or other form of storage media which may be accessed by the computing device 1000 and may store desired information, or a suitable combination thereof.

The communication bus 1300 may interconnect various other components of the computing device 1000, including the processor 1100 and the computer readable storage medium 1200.

The computing device 1000 may also include one or more input/output interfaces 1500 and one or more network communication interfaces 1600 providing interfaces for one or more input/output devices 1400. The input/output interface 1500 and the network communication interface 1600 may be connected to the communication bus 1300. The network may be implemented as one of a cellular network, such as global system for mobile communications (GSM), enhanced data rates for GSM evolution (EDGE), general packet radio service (GPRS), code division multiple access (CDMA), time division-CDMA (TD-CDMA), universal mobile telecommunications system (UMTS), long term evolution (LTE), or another cellular network.

The input/output device 1400 may be connected to other components of the computing device 1000 through the input/output interface 1500. The exemplary input/output device 1400 may include input devices such as a pointing device (such as a mouse or trackpad), a keyboard, a touch input device (such as a touchpad or a touchscreen), a voice or sound input device, various types of sensor devices and/or photographing devices, and/or output devices such as a display device, a printer, a speaker, and/or a network card. The exemplary input/output device 1400 may be included in the computing device 1000 as a component included in the computing device 1000, or may be connected to the computing device 1000 as a device distinct from the computing device 1000.

An embodiment of the present disclosure may include a program for performing the methods described herein on a computer, and a computer-readable recording medium including the program. The computer-readable recording medium may include program commands, local data files, local data structures, or the like, alone or in combination. The medium may be specially designed and configured for the present disclosure, or may be commonly used in the field of computer software. Examples of computer-readable storage media may include magnetic media such as hard disks, floppy disks and magnetic tape, optical storage media such as CD-ROMs and DVDs, and hardware devices specifically configured to store and perform program commands, such as ROMs, RAMs, and flash memory. Examples of the program may include machine language code, such as produced by a compiler, and also high-level language code which may be executed by a computer using an interpreter.

According to the aforementioned embodiments, in a vehicle such as a commercial vehicle, when controlling regenerative braking, the regenerative braking torque may be variably controlled according to driving conditions of the vehicle, such as basic mode control using a high level of maximum allowable torque, or safe mode control using a limited maximum allowable torque, depending on the driving conditions of the vehicle, such as a vehicle state and weather condition, such as the vehicle weight and speed.

For example, when a high level of maximum allowable torque is required, such as when the vehicle weight is high, the maximum allowable regenerative torque may be increased, and in case in which limitation of the maximum allowable torque is required, such as when the road friction is low due to snow or rain, and wheel slippage is likely to occur, the maximum allowable regenerative torque may be appropriately limited.

Accordingly, the maximum allowable regenerative torque may be appropriately varied to be high or low depending on the driving conditions, such that the regenerative torque allowable range may be used more widely, and if desired, by limiting the maximum allowable regenerative torque, the effect of assuring driving stability may be provided.

The motor may be implemented by simple structural modifications, and there may be no major modification compared to a general motor, but performance may be improved, such that the effect of substantially reducing costs may be obtained.

While the embodiments have been illustrated and described above, it will be apparent to those skilled in the art that modifications and variations could be manufactured without departing from the scope of the present disclosure as defined by the appended claims.

What is claimed is:

1. An apparatus for controlling vehicle regenerative torque, the apparatus comprising:
an information acquisition portion configured to obtain vehicle state information including a speed and a weight of a vehicle and navigation information including weather condition information;
a basic mode controller configured to enter a basic mode while the vehicle travels to receive a variable maximum torque map determined based on information obtained by the information acquisition portion and to perform a basic mode control logic; and
a safe mode controller configured to enter a safe mode when safe mode entry conditions are satisfied and to receive a limited maximum allowable torque value determined based on information obtained by the information acquisition portion.

2. The apparatus of claim 1, wherein the information acquisition portion is configured to obtain surrounding object sensing information including speed information of a front vehicle, vehicle input information, and wheel slippage information.

3. The apparatus of claim 2, wherein the basic mode controller is configured to perform unit deceleration control when a deceleration condition is satisfied based on a maximum allowable torque value of the received variable maximum torque map and to perform low-friction control when wheel slippage occurs.

4. The apparatus of claim 3, wherein the safe mode controller is configured to determine safe mode entry conditions based on a number of times low-friction control is performed, to perform deceleration control when the deceleration condition is satisfied based on the received limited maximum allowable torque value after entering the safe mode, and to perform low-friction control when wheel slippage occurs.

5. The apparatus of claim 4, wherein the information acquisition portion includes:
a first information acquisition portion configured to obtain a speed and a weight of a vehicle corresponding to vehicle state information using at least one of acceleration information, yaw information, accelerator position information, motor torque information, vehicle speed information, wheel speed information, and wheel slippage information;
a second information acquisition portion configured to obtain speed camera position information and weather condition information included in the navigation information;
a third information acquisition portion configured to obtain the surrounding object sensing information including speed and relative distance information of a front vehicle included in the surrounding object sensing information, and relative speed information; and
a fourth information acquisition portion configured to obtain vehicle input information including a regenerative braking automatic mode operation signal and a paddle shift operation signal.

6. The apparatus of claim 5, wherein the basic mode controller includes:
a first information input portion configured to receive vehicle state information including a vehicle speed and a vehicle weight obtained by the information acquisition portion and weather condition information including rain information or snow information;
a first maximum allowable torque determination portion configured to determine a first variable maximum torque map when no snow and rain falls, to determine a second variable maximum torque map when rain falls, and to determine a third variable maximum torque map when rain falls based on the vehicle state information and weather condition information; and
a first torque controller configured to enter a basic mode when regenerative braking automatic mode is selected, to receive a variable maximum torque map determined based on current weather conditions, to operate a deceleration control logic portion within a maximum allowable torque value range of the received variable maximum torque map, and to operate a low-friction control logic portion when wheel slippage occurs.

7. The apparatus of claim 6,
wherein the first maximum allowable torque determination portion is configured to determine the first variable maximum torque map using a reference maximum allowable torque value having an increased maximum allowable torque value according to a speed and a weight of the vehicle based on the vehicle state information and weather condition information when no rain or snow falls,
wherein the first maximum allowable torque determination portion is configured to determine a second variable maximum torque map having a maximum allowable torque value lower than the first variable maximum torque map based on the vehicle state information and weather condition information when rain falls, and
wherein the first maximum allowable torque determination portion is configured to determine a third variable maximum torque map having a maximum allowable torque value lower than the second variable maximum torque map based on the vehicle state information and weather condition information during snowfall.

8. The apparatus of claim 7, wherein the first variable maximum torque map includes a maximum allowable torque value increasing as a vehicle weight included in the vehicle state information increases using the reference maximum allowable torque value and includes a maximum allowable torque value increasing as a vehicle speed included in the vehicle state information decreases.

9. The apparatus of claim 7,
wherein the second variable maximum torque map includes a maximum allowable torque value obtained by reducing a maximum allowable torque value of the first variable maximum torque map by a first ratio based on the weather condition information when rain falls, and
wherein the third variable maximum torque map includes a maximum allowable torque value obtained by reducing a maximum allowable torque value of the first variable maximum torque map by a second ratio during snowfall, and the second ratio is smaller than the first ratio.

10. The apparatus of claim 5, wherein the safe mode controller includes:
a safe mode entry determination portion configured to determine whether a safe mode entry condition is satisfied based on the number of times low-friction control is performed;
a second information input portion configured to enter a safe mode when the safe mode entry condition is satisfied by the safe mode entry determination portion, and to receive weather condition information including rain information or snow information obtained by the information acquisition portion;
a second maximum allowable torque determination portion configured to determine a first limited maximum allowable torque value when snow and rain do not fall, to determine a second limited maximum allowable torque value when rain falls, and to determine a third limited maximum allowable torque value when rain falls based on the weather condition information; and
a second torque controller configured to enter a safe mode when a regenerative braking automatic mode is selected, to receive a limited maximum allowable torque value determined under current weather condition, to operate a deceleration control logic portion under a deceleration condition, and to perform a low-friction control logic portion when wheel slippage occurs within a range of the received limited maximum allowable torque value.

11. The apparatus of claim 10, wherein the second maximum allowable torque determination portion is configured to determine a first limited maximum allowable torque value using a reference maximum allowable torque value based on the vehicle state information and weather condition information when no rain or snow falls,
wherein the second maximum allowable torque determination portion is configured to determine a second limited maximum allowable torque value obtained by reducing the first limited maximum allowable torque value by a first ratio based on the vehicle state information and weather condition information when rain falls, and
wherein the second maximum allowable torque determination portion is configured to determine a third limited maximum allowable torque value obtained by reducing the first limited maximum allowable torque value by a second ratio based on the vehicle state information and weather condition information during snowfall, and the second ratio is smaller than the first ratio.

12. The apparatus of claim 6, wherein the deceleration control logic portion includes:
a deceleration condition determination portion configured to determine whether a road on which the vehicle travels satisfies a deceleration condition based on information obtained by the information acquisition portion in the regenerative braking automatic mode; and
a deceleration torque controller configured to control deceleration torque corresponding to the deceleration condition within a range of a maximum allowable torque value during the deceleration condition by performing a deceleration control logic when one of deceleration conditions is satisfied in the deceleration condition determination portion.

13. The apparatus of claim 10, wherein the deceleration control logic portion includes:
a deceleration condition determination portion configured to determine whether a on which the vehicle travels satisfies a deceleration condition based on information obtained by the information acquisition portion in the regenerative braking automatic mode; and
a deceleration torque controller configured to control deceleration torque corresponding to the deceleration condition within a range of a maximum allowable torque value during the deceleration condition by performing a deceleration control logic when one of deceleration conditions is satisfied in the deceleration condition determination portion.

14. The apparatus of claim 6, wherein the low-friction control logic portion includes:
a low-friction condition determination portion configured to determine whether a on which the vehicle travels satisfies a low-friction condition based on the wheel slippage information in the regenerative braking automatic mode; and
a low-friction torque controller configured to, when the low-friction condition is satisfied, feedback-control a low-friction torque such that a current wheel slippage value becomes a wheel slippage target value or lower during the corresponding low-friction condition by performing a low-friction control logic.

15. The apparatus of claim 10, wherein the low-friction control logic portion includes:
a low-friction condition determination portion configured to determine whether a road on which the vehicle travels satisfies a low-friction condition based on the wheel slippage information in the regenerative braking automatic mode; and
a low-friction torque controller configured to, when the low-friction condition is satisfied, feedback-control low-friction torque such that a current wheel slippage value becomes a wheel slippage target value or lower during the corresponding low-friction condition.

16. A method of controlling vehicle regenerative torque, the method comprising:
an information obtaining operation of obtaining navigation information including vehicle state information including a speed and a weight of a vehicle and weather condition information by an information acquisition portion;
a basic mode performing operation of entering a basic mode while a vehicle travels, receiving a variable maximum torque map determined based on the obtained information, and performing a basic mode control logic by a basic mode controller; and
a safe mode performing operation of entering a safe mode when a safe mode entry condition is satisfied and performing a safe mode control logic by receiving a limited maximum allowable torque value determined based on information obtained by the information acquisition portion.

17. The method of claim 16, wherein the information obtaining operation includes further obtaining surrounding object sensing information including speed information of a front vehicle, vehicle input information and wheel slippage information.

18. The method of claim 17, wherein the basic mode performing operation includes performing deceleration control when the deceleration condition is satisfied based on a maximum allowable torque value of the received variable maximum torque map, and performing low-friction control when wheel slippage occurs.

19. The method of claim 18, wherein the safe mode performing operation includes determining a safe mode entry condition based on a number of times low-friction control is performed, and after entering a safe mode, performing deceleration control when the deceleration condition is satisfied based on the received limited maximum allowable torque value, and performing low-friction control when wheel slippage occurs.

20. The method of claim 19, wherein the basic mode performing operation includes:
a first information inputting operation of receiving vehicle state information including the obtained vehicle speed and vehicle weight and weather condition information including rain information or snow information;
a first maximum allowable torque determining operation of determining a first variable maximum torque map when no snow or rain falls, determining a second variable maximum torque map when rain falls, and determining a third variable maximum torque map when rain falls based on the vehicle state information and weather condition information; and
a basic mode controlling operation of entering a basic mode when a regenerative braking automatic mode is selected, receiving a variable maximum torque map determined according to a current weather condition, performing a deceleration control logic when a deceleration condition occurs and performing a low-friction control logic when wheel slippage occurs within a range of a maximum allowable torque value of the variable maximum torque map.

21. The method of claim 20, wherein the safe mode performing operation includes:
a safe mode entry determining operation of determining whether a safe mode entry condition is satisfied based on the number of times low-friction control is performed;
a second information inputting operation of entering a safe mode and receiving weather condition information including the obtained rain information or snow information when the safe mode entry condition is satisfied;
a second maximum allowable torque determining operation of determining a first limited maximum allowable torque value when no snow and rain falls, determining a second limited maximum allowable torque value when rain falls, and determining a third limited maximum allowable torque value when rain falls; and
a safe mode control operation of entering a safe mode when a regenerative braking automatic mode is selected, receiving a limited maximum allowable torque value determined according to a current weather condition, performing a deceleration control logic when a deceleration condition occurs and performing a low-friction control logic when wheel slippage occurs within a range of the limited maximum allowable torque value.

22. The method of claim 20, wherein the first maximum allowable torque determining operation includes:
determining the first variable maximum torque map having an increased maximum allowable torque value according to a speed and a weight of the vehicle using a reference maximum allowable torque value based on the vehicle state information and weather condition information when no rain or snow falls;
determining the second variable maximum torque map having a maximum allowable torque value lower than a maximum allowable torque value of the first variable maximum torque map based on the vehicle state information and weather condition information when rain falls; and
determining a third variable maximum torque map having a maximum allowable torque value lower than a maximum allowable torque value of the second variable maximum torque map based on the vehicle state information and weather condition information during snowfall.

23. The method of claim 22, wherein the first variable maximum torque map includes a maximum allowable torque value increasing as a vehicle weight included in the vehicle state information increases using the reference maximum allowable torque value, and a maximum allowable torque value increasing as a vehicle speed included in the vehicle state information decreases.

24. The method of claim 22, wherein the second variable maximum torque map includes a maximum allowable torque value obtained by reducing a maximum allowable torque value of the first variable maximum torque map by a first ratio based on the weather condition information when rain falls, and
wherein the third variable maximum torque map includes a maximum allowable torque value obtained by reducing a second ratio of a maximum allowable torque value of the first variable maximum torque map based on the weather condition information during snowfall, and the second ratio is smaller than the first ratio.

25. The method of claim 21, wherein the second maximum allowable torque determining operation includes:
determining a first limited maximum allowable torque value using a reference maximum allowable torque value based on the vehicle state information and weather condition information when no rain or snow falls;
determining a second limited maximum allowable torque value obtained by reducing the first limited maximum allowable torque value by a first ratio based on the vehicle state information and weather condition information when rain falls; and
determining a third limited maximum allowable torque value obtained by reducing the first limited maximum allowable torque value by a second ratio based on the vehicle state information and weather condition information during snowfall,
wherein the second ratio is smaller than the first ratio.

26. The method of claim 20, wherein the deceleration control logic performing operation includes:
a deceleration condition determining operation of determining whether a road on which the vehicle travels satisfies a deceleration condition based on the obtained information in the regenerative braking automatic mode; and
a deceleration torque control operation of controlling deceleration torque corresponding to a deceleration condition within a range of a maximum allowable torque value during the deceleration condition by performing deceleration control logic when one of deceleration conditions is satisfied.

27. The method of claim 21, wherein the deceleration control logic performing operation includes:
a deceleration condition determining operation of determining whether a road on which a vehicle travels satisfies a deceleration condition based on the obtained information in the regenerative braking automatic mode; and
a deceleration torque control operation of controlling deceleration torque corresponding to a deceleration condition within a range of a maximum allowable torque value during the deceleration condition by performing a deceleration control logic when one of deceleration conditions is satisfied.

28. The method of claim 20, wherein the low-friction control logic performing operation includes:
a low-friction condition determine operation of determining whether a road on which the vehicle travels satisfies a low-friction condition based on the wheel slippage information in the regenerative braking automatic mode; and
a low-friction torque control operation of feedback-controlling low-friction torque such that a current wheel slippage value becomes a wheel slippage target value or lower during a corresponding low-friction condition by performing a low-friction control logic when the low-friction condition is satisfied.

29. The method of claim 21, wherein the low-friction control logic performing operation includes:
a low-friction condition determine operation of determining whether a road on which the vehicle travels satisfies a low-friction condition based on the wheel slippage information in the regenerative braking automatic mode; and
a low-friction torque control operation of feedback controlling low-friction torque such that a current wheel slippage value becomes a wheel slippage target value or lower during a corresponding low-friction condition by performing a low-friction control logic when the low-friction condition is satisfied.
